(19) United States
(12) Patent Application Publication
(10) Pub. No.: US 2023/0204037 A1
(43) Pub. Date: Jun. 29, 2023

(54) CENTRIFUGAL COMPRESSOR

(71) Applicant: KABUSHIKI KAISHA TOYOTA JIDOSHOKKI, Aichi (JP)

(72) Inventors: Hidefumi MORI, Aichi (JP); Junya SUZUKI, Aichi (JP)

(73) Assignee: KABUSHIKI KAISHA TOYOTA JIDOSHOKKI, Aichi (JP)

(21) Appl. No.: 18/079,592

(22) Filed: Dec. 12, 2022

(30) Foreign Application Priority Data
Dec. 27, 2021 (JP) 2021-213074

(51) Int. Cl. F04D 17/10; F04D 29/051; F04D 29/38

(52) U.S. Cl. CPC F04D 17/10; F04D 29/38; F04D 29/051; F05D 2240/52; F05D 2300/507

(57) ABSTRACT

A centrifugal compressor includes a compressor impeller that compresses air, a motor rotating the compressor impeller, and a housing including an impeller chamber, a motor chamber, and an inlet from which the air is drawn into the impeller chamber. The motor includes a stator and a rotor including a tubular member, a magnetic body, and a first shaft member and a second shaft member. The rotor includes an axial passage, a radial passage, and a connecting rod connecting the first shaft member with the second shaft member and forming a gap serving as a part of the axial passage. The housing includes a discharge port from which the air is discharged to an outside of the housing. The air outside the housing is introduced from the inlet into the motor chamber through the axial passage and the radial passage to cool the magnetic body.

### CROSS-REFERENCE TO RELATED APPLICATION

This application claims priority to Japanese Patent Application No. 2021-213074 filed on Dec. 27, 2021, the entire disclosure of which is incorporated herein by reference.

### BACKGROUND ART

The present disclosure relates to a centrifugal compressor.

A centrifugal compressor includes a compressor impeller, a motor, and a housing. The compressor impeller compresses air. The motor rotates the compressor impeller. The housing has a tubular shape. The housing includes an impeller chamber, a motor chamber, and an inlet. The impeller chamber accommodates the compressor impeller. The motor chamber accommodates the motor. Air is drawn from the inlet into the impeller chamber.

The motor includes a stator and a rotor. The stator is fixed to the housing. The rotor is disposed inside the stator. The rotor may have a tubular member, a magnetic body, a first shaft member, and a second shaft member. The magnetic body is fixed inside the tubular member. The first shaft member and the second shaft member are disposed at opposite ends of the magnetic body in an axial direction of the tubular member. The compressor impeller is connected to the first shaft member, for example.

In this kind of centrifugal compressor, heat is generated in the magnetic body due to eddy current generated in the magnetic body. Part of the air compressed by the compressor impeller may be introduced into the motor chamber, for example, as disclosed in Japanese Patent Application Publication No. 2011-202588. As described above, the compressed air is introduced into the motor chamber, so that the magnetic body is cooled by the compressed air.

However, the temperature of the air compressed by the compressor impeller is higher as compared with air before compression, so that the magnetic body may be insufficiently cooled. Therefore, in this kind of centrifugal compressor, it is desirable to efficiently cool the magnetic body. It is also desirable to improve an output of the motor in the centrifugal compressor.

### SUMMARY

In accordance with an aspect of the present disclosure, there is provided a centrifugal compressor that includes: a compressor impeller that compresses air; a motor rotating the compressor impeller; and a housing including an impeller chamber that accommodates the compressor impeller, a motor chamber that accommodates the motor, and an inlet from which the air is drawn into the impeller chamber. The motor includes a stator fixed to the housing, and a rotor disposed inside the stator. The rotor includes a tubular member, a magnetic body fixed to an inside of the tubular member, and a first shaft member and a second shaft member provided on opposite sides of the magnetic body in an axial direction of the tubular member. The compressor impeller is connected to the first shaft member. The rotor includes: an axial passage that extends inside the rotor in an axial direction of the rotor and is opened at one end of the first shaft member close to the compressor impeller to communicate with the inlet; a radial passage that communicates with the axial passage and extends in a radial direction of the second shaft member to communicate with the motor chamber; and a connecting rod made of a magnetic material, the connecting rod connecting the first shaft member with the second shaft member and forming a gap serving as a part of the axial passage between an inner surface of the magnetic body and the connecting rod. The housing includes a discharge port from which the air introduced into the motor chamber is discharged to an outside of the housing. The air outside the housing is introduced from the inlet into the motor chamber through the axial passage and the radial passage to cool the magnetic body. The air introduced into the motor chamber is discharged from the discharge port.

Other aspects and advantages of the disclosure will become apparent from the following description, taken in conjunction with the accompanying drawings, illustrating by way of example the principles of the disclosure.

### BRIEF DESCRIPTION OF THE DRAWINGS

The disclosure, together with objects and advantages thereof, may best be understood by reference to the following description of the embodiments together with the accompanying drawings in which:

FIG. 1 is a cross-sectional view of a centrifugal compressor according to an embodiment;

FIG. 2 is an enlarged cross-sectional view of a part of the centrifugal compressor;

FIG. 3 is an enlarged cross-sectional view of a part of the centrifugal compressor;

FIG. 4 is an enlarged cross-sectional view of a part of the centrifugal compressor;

FIG. 5 is a cross-sectional view of a tubular member, a permanent magnet, and a connecting rod;

FIG. 6 is a cross-sectional view of a first shaft member and the connecting rod;

FIG. 7 is a cross-sectional view of a centrifugal compressor according to another embodiment;

FIG. 8 is an enlarged cross-sectional view of a part of the centrifugal compressor; and

FIG. 9 is an enlarged cross-sectional view of a part of the centrifugal compressor.

### DETAILED DESCRIPTION OF THE EMBODIMENTS

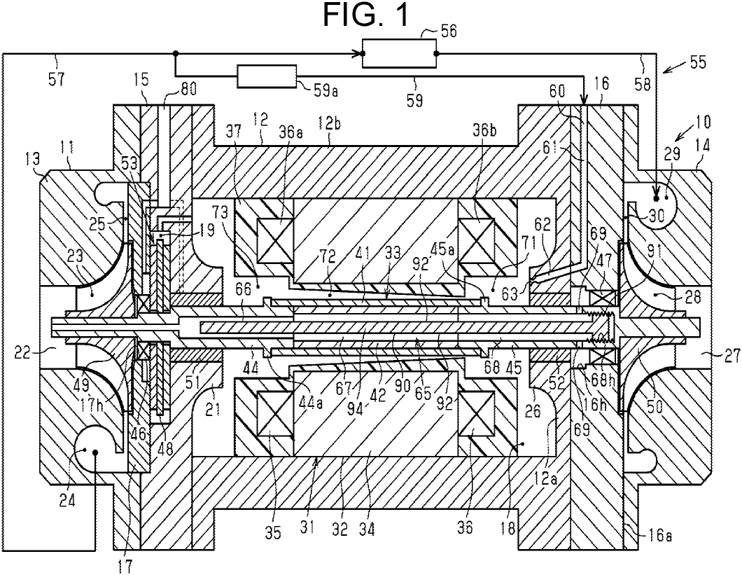

The following will describe an embodiment of a centrifugal compressor with reference to FIGS. 1 to 6. The centrifugal compressor of the present embodiment is mounted on a fuel cell vehicle. The centrifugal compressor compresses air.

### Overall Configuration of Centrifugal Compressor 10

As illustrated in FIG. 1, a centrifugal compressor 10 includes a housing 11. The housing 11 is made of a metallic material, such as aluminum. The housing 11 has a tubular shape. The housing 11 includes a motor housing 12, a compressor housing 13, a turbine housing 14, a first plate 15, a second plate 16, and a seal plate 17.

The motor housing 12 has a tubular shape. The motor housing 12 has an end wall 12a having a plate-like shape and a circumferential wall 12b. The circumferential wall 12b extends in the tubular shape from an outer periphery of the end wall 12a. The first plate 15 is connected to and closes an opened end of the circumferential wall 12b of the motor housing 12. The end wall 12a and the circumferential wall 12b of the motor housing 12 and the first plate 15 define a motor chamber 18. Thus, the housing 11 includes the motor chamber 18.

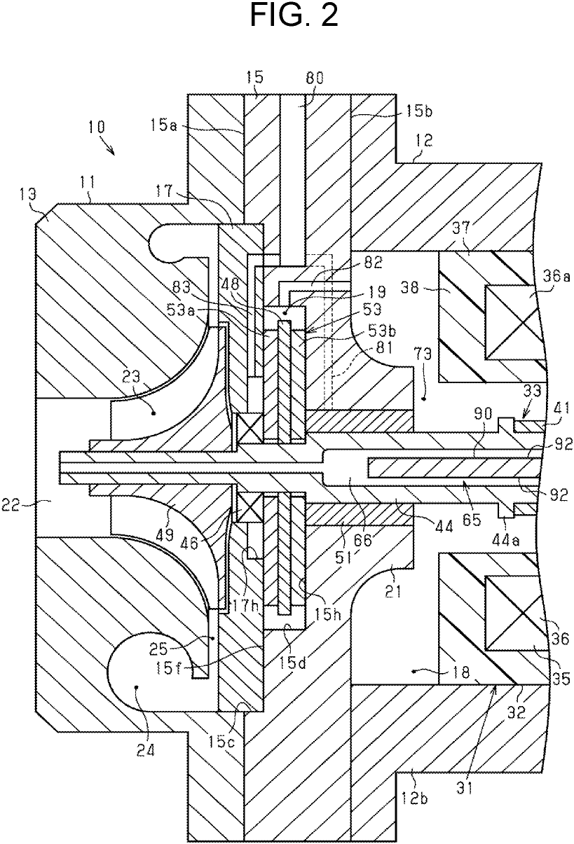

As illustrated in FIG. 2, a first recess 15c and a second recess 15d are formed in an end surface 15a of the first plate 15 that is opposite from the motor housing 12. The first recess 15c and the second recess 15d each have a circular hole shape. An inner diameter of the first recess 15c is greater than that of the second recess 15d. The second recess 15d is formed in a bottom surface 15f of the first recess 15c. The first recess 15c is formed coaxially with the second recess 15d.

The seal plate 17 is fitted into the first recess 15c. The seal plate 17 is attached to the first plate 15 using a bolt (not illustrated), for example. The seal plate 17 closes an opening of the second recess 15d. The seal plate 17 and the second recess 15d define a thrust bearing accommodation chamber 19. Therefore, the housing 11 includes the thrust bearing accommodation chamber 19. The seal plate 17 has a shaft insertion hole 17h. The shaft insertion hole 17h is formed at a central portion of the seal plate 17. The shaft insertion hole 17h is opened at the thrust bearing accommodation chamber 19.

The first plate 15 includes a first radial bearing holding portion 21. The first radial bearing holding portion 21 has a cylindrical shape. The first radial bearing holding portion 21 projects into the motor chamber 18 from a central portion of an end surface 15b of the first plate 15 that is close to the motor housing 12. The first radial bearing holding portion 21 communicates with the motor chamber 18. The first radial bearing holding portion 21 extends through the first plate 15 and is opened at a bottom surface 15h of the second recess 15d. Thus, the first radial bearing holding portion 21 communicates with the thrust bearing accommodation chamber 19. Therefore, the thrust bearing accommodation chamber 19 communicates with the first radial bearing holding portion 21. The first radial bearing holding portion 21 is formed coaxially with the first recess 15c and the second recess 15d.

The compressor housing 13 has a tubular shape. The compressor housing 13 has an inlet 22 having a circular hole shape. The compressor housing 13 is connected to the end surface 15a of the first plate 15 in a state where an axis of the inlet 22 coincides with an axis of the shaft insertion hole 17h of the seal plate 17. The inlet 22 is opened at an end surface of the compressor housing 13 that is opposite from the first plate 15.

An impeller chamber 23, a discharge chamber 24, and a compressor diffuser passage 25 are formed between the compressor housing 13 and the seal plate 17. Thus, the housing 11 has the impeller chamber 23. The seal plate 17 separates the impeller chamber 23 from the thrust bearing accommodation chamber 19. The impeller chamber 23 communicates with the inlet 22. The impeller chamber 23 has a substantially truncated cone hole shape that gradually increases in its diameter from the inlet 22 toward the seal plate 17. The discharge chamber 24 extends about the axis of the inlet 22 around the impeller chamber 23. The impeller chamber 23 communicates with the discharge chamber 24 through the compressor diffuser passage 25. The impeller chamber 23 communicates with the shaft insertion hole 17h of the seal plate 17.

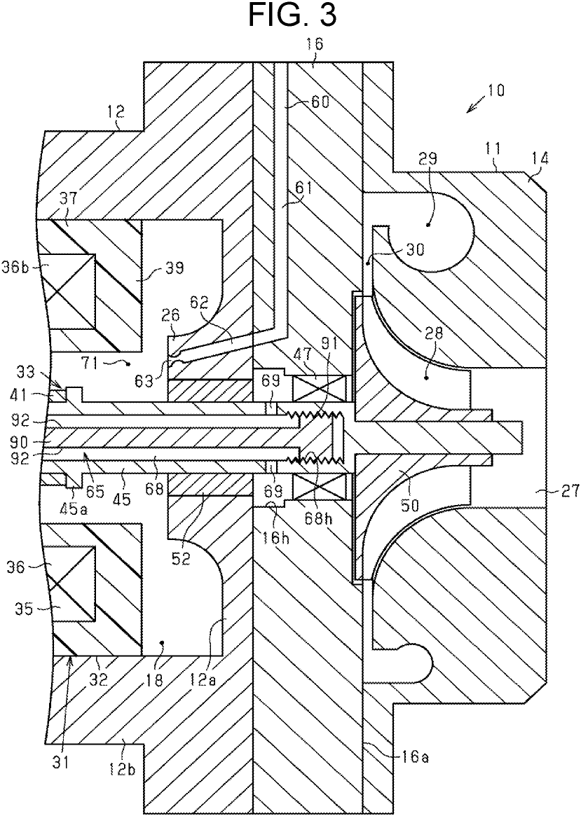

As illustrated in FIG. 3, the end wall 12a of the motor housing 12 has a second radial bearing holding portion 26. The second radial bearing holding portion 26 has a cylindrical shape. The second radial bearing holding portion 26 projects into the motor chamber 18 from a central portion of an inner surface of the end wall 12a of the motor housing 12. The second radial bearing holding portion 26 communicates with the motor chamber 18. The second radial bearing holding portion 26 extends through the end wall 12a of the motor housing 12 and is opened at an outer surface of the end wall 12a. The first radial bearing holding portion 21 is formed coaxially with the second radial bearing holding portion 26.

The second plate 16 is connected to the outer surface of the end wall 12a of the motor housing 12. The second plate 16 has a shaft insertion hole 16h. The shaft insertion hole 16h is formed in a central portion of the second plate 16.

The turbine housing 14 has a tubular shape. The turbine housing 14 has an outlet 27 having a circular hole shape. The turbine housing 14 is connected to an end surface 16a of the second plate 16 opposite from the motor housing 12 in a state where the outlet 27 is formed coaxially with the shaft insertion hole 16h of the second plate 16. The outlet 27 is opened at an end surface of the turbine housing 14 opposite from the second plate 16.

A turbine chamber 28, a suction chamber 29, and a communication passage 30 are formed between the turbine housing 14 and the end surface 16a of the second plate 16. The turbine chamber 28 communicates with the outlet 27. The suction chamber 29 extends about an axis of the outlet 27 around the turbine chamber 28. The turbine chamber 28 communicates with the suction chamber 29 through the communication passage 30. The turbine chamber 28 communicates with the shaft insertion hole 16h of the second plate 16.

### Configuration of Motor 31

As illustrated in FIG. 1, the centrifugal compressor 10 includes a motor 31. The motor chamber 18 accommodates the motor 31. Thus, the housing 11 accommodates the motor 31.

The motor 31 includes a stator 32 and a rotor 33. The stator 32 includes a stator core 34 having a tubular shape and a coil 35. The coil 35 is wound around the stator core 34. The stator core 34 is fixed onto an inner peripheral surface of the circumferential wall 12b of the motor housing 12. Coil ends 36 of the coil 35 project on opposite end surfaces of the stator core 34. In the following description, a “first coil end 36a” refers to one of the coil ends 36 on one of the opposite end surfaces of the stator core 34 that is close to the first plate 15. A “second coil end 36b” refers to the other of the coil ends 36 on the other of the opposite end surfaces of the stator core 34 that is close to the end wall 12a of the motor housing 12.

### Configuration of Resin Portion 37

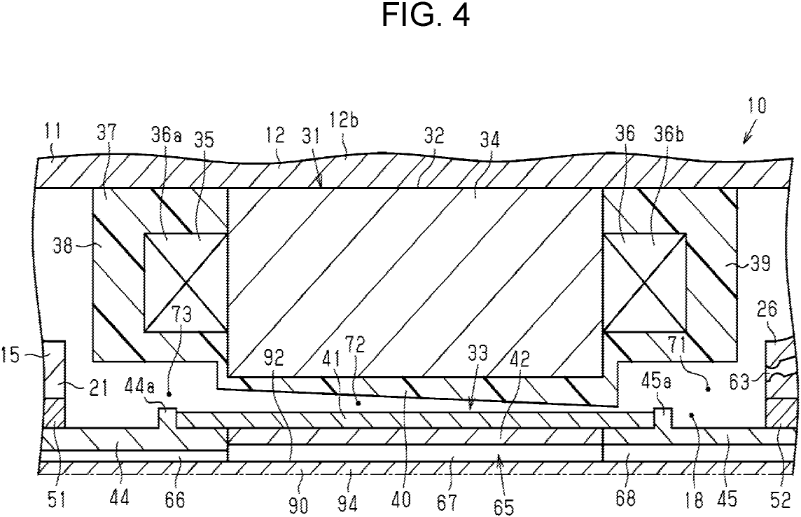

As illustrated in FIG. 4, the stator 32 includes a resin portion 37. The resin portion 37 covers the stator core 34 and the coil ends 36. The resin portion 37 has a first resin portion 38, a second resin portion 39, and a third resin portion 40. Thus, the stator 32 includes the first resin portion 38, the second resin portion 39, and the third resin portion 40. The first resin portion 38 having a tubular shape covers the first coil end 36a with a resin. The second resin portion 39 having a tubular shape covers the second coil end 36b with the resin. The third resin portion 40 having a tubular shape covers the inner peripheral surface of the stator core 34 with the resin. The third resin portion 40 extends in an axial direction of the stator core 34 inside the stator core 34. The third resin portion 40 connects the first resin portion 38 and the second resin portion 39. An inner peripheral surface of the third resin portion 40 is a cone hole that increases in an inner diameter of the third resin portion 40 from the second resin portion 39 toward the first resin portion 38.

### Configuration of Rotor 33

The rotor 33 is disposed inside the stator 32. The rotor 33 includes a tubular member 41, a permanent magnet 42 serving as a magnetic body, a first shaft member 44, and a second shaft member 45. In the present embodiment, the tubular member 41 is made of titanium alloy, for example. The tubular member 41 has a tubular shape in which an axis of the tubular member 41 extends linearly. An axial direction of the tubular member 41 coincides with that of the rotor 33. An outer diameter of the tubular member 41 is fixed in a constant size. The permanent magnet 42 has a cylindrical shape. The permanent magnet 42 is disposed inside the tubular member 41. An axis of the permanent magnet 42 coincides with that of the tubular member 41. The permanent magnet 42 is press-fitted into an inner peripheral surface of the tubular member 41. The permanent magnet 42 is thus fixed inside the tubular member 41.

The permanent magnet 42 has opposite end surfaces in the axial direction thereof at positions corresponding to positions of the opposite end surfaces of the stator core 34 in a radial direction thereof. A length of the permanent magnet 42 extending in the axial direction thereof is shorter than a length of the tubular member 41 extending in the axial direction thereof. The opposite end surfaces of the permanent magnet 42 are positioned inside the tubular member 41. The tubular member 41 has opposite ends in the axial direction thereof projecting beyond the opposite end surfaces of the permanent magnet 42 in the axial direction thereof. The opposite ends of the tubular member 41 project beyond the opposite end surfaces of the stator core 34 in the axial direction thereof.

As illustrated in FIG. 5, the permanent magnet 42 is magnetized in a radial direction of the permanent magnet 42. Specifically, the permanent magnet 42 having the cylindrical shape is magnetized in the radial direction of the permanent magnet 42 to have a north pole on one side of the permanent magnet 42 and a south pole on the other side of the permanent magnet 42 in the radial direction thereof. In FIG. 5, the south pole of the permanent magnet 42 is hatched with dots.

As illustrated in FIG. 1, the first shaft member 44 and the second shaft member 45 are disposed on opposite sides of the permanent magnet 42 in the axial direction of the tubular member 41. The first shaft member 44 and the second shaft member 45 are made of iron, for example.

The first shaft member 44 has a cylindrical shape. A first end of the first shaft member 44 is inserted into a first end of the tubular member 41. A second end of the first shaft member 44 extends through the motor chamber 18, an inside of the first radial bearing holding portion 21, the thrust bearing accommodation chamber 19, and the shaft insertion hole 17h, and projects into the impeller chamber 23.

The first shaft member 44 includes a first flange portion 44a. The first flange portion 44a annularly projects from an outer peripheral surface of the first shaft member 44. The first flange portion 44a faces the first end of the tubular member 41 in the axial direction of the tubular member 41.

The second shaft member 45 has a cylindrical shape. A first end of the second shaft member 45 is inserted into a second end of the tubular member 41. A second end of the second shaft member 45 extends through the motor chamber 18, an inside of the second radial bearing holding portion 26, and the shaft insertion hole 16h, and projects into the turbine chamber 28.

The second shaft member 45 includes a second flange portion 45a. The second flange portion 45a annularly projects from an outer peripheral surface of the second shaft member 45. The second flange portion 45a faces the second end of the tubular member 41 in the axial direction of the tubular member 41.

A first seal member 46 is provided between the shaft insertion hole 17h of the seal plate 17 and the first shaft member 44. The first seal member 46 suppresses leakage of air flowing from the impeller chamber 23 toward the motor chamber 18. A second seal member 47 is provided between the shaft insertion hole 16h of the second plate 16 and the second shaft member 45. The second seal member 47 suppresses leakage of air flowing from the turbine chamber 28 toward the motor chamber 18. Each of the first seal member 46 and the second seal member 47 is a seal ring, for example.

### Supporting Portion 48

The centrifugal compressor 10 includes a supporting portion 48. The supporting portion 48 annularly projects from the outer peripheral surface of the first shaft member 44. Therefore, the supporting portion 48 having an annular shape is provided on the outer peripheral surface of the first shaft member 44. The supporting portion 48 has a disk shape. The supporting portion 48 is fixed to the outer peripheral surface of the first shaft member 44 in a state where the supporting portion 48 annularly projects outward from the outer peripheral surface of the first shaft member 44 in a radial direction thereof. Therefore, the supporting portion 48 is a member independent from the first shaft member 44. The supporting portion 48 is disposed inside the thrust bearing accommodation chamber 19. The supporting portion 48 rotates together with the first shaft member 44.

### Compressor Impeller 49

The centrifugal compressor 10 includes the compressor impeller 49. The compressor impeller 49 is attached to the second end of the first shaft member 44. Thus, the compressor impeller 49 is connected to the first shaft member 44. The compressor impeller 49 is disposed in the first shaft member 44 closer to the second end of the first shaft member 44 than the supporting portion 48 is. The compressor impeller 49 has a tubular shape that gradually reduces its diameter from a rear surface to a distal end surface of the compressor impeller 49. The compressor impeller 49 is accommodated in the impeller chamber 23. An outer edge of the compressor impeller 49 extends along the inner peripheral surface of the impeller chamber 23. The compressor impeller 49 rotates together with the first shaft member 44 to compresses air.

### Turbine Wheel 50

The centrifugal compressor 10 includes a turbine wheel 50. The turbine wheel 50 is attached to the second end of the second shaft member 45. The turbine wheel 50 is accommodated in the turbine chamber 28. The turbine wheel 50 rotates together with the second shaft member 45.

### First Radial Bearing 51 and Second Radial Bearing 52

The centrifugal compressor 10 includes a first radial bearing 51 and a second radial bearing 52. The first radial bearing 51 has a cylindrical shape. The first radial bearing 51 is held by the first radial bearing holding portion 21. The second radial bearing 52 has a cylindrical shape. The second radial bearing 52 is held by the second radial bearing holding portion 26.

The first radial bearing 51 rotatably supports the first shaft member 44 in a radial direction. The second radial bearing 52 rotatably supports the second shaft member 45 in the radial direction. The first radial bearing 51 and the second radial bearing 52 rotatably support the rotor 33 at opposite positions of the tubular member 41 in the axial direction thereof. The “radial direction” is a direction orthogonal to the axial direction of the tubular member 41.

### Thrust Bearing 53

As illustrated in FIG. 2, the centrifugal compressor 10 includes a thrust bearing 53. The thrust bearing 53 is accommodated in the thrust bearing accommodation chamber 19. The thrust bearing 53 has a first thrust bearing portion 53a and a second thrust bearing portion 53b. The first thrust bearing portion 53a and the second thrust bearing portion 53b sandwich the supporting portion 48. The first thrust bearing portion 53a is disposed close to the compressor impeller 49 relative to the supporting portion 48. The second thrust bearing portion 53b is disposed close to the first radial bearing 51 with respect to the supporting portion 48. The first thrust bearing portion 53a and the second thrust bearing portion 53b rotatably support the supporting portion 48 in the thrust direction. Thus, the thrust bearing 53 is provided between the compressor impeller 49 and the first radial bearing 51 and rotatably supports the rotor 33 in the thrust direction via the supporting portion 48. The “thrust direction” is a direction parallel to the axial direction of the tubular member 41. As such, the rotor 33 is rotatably supported in the housing 11.

### Fuel Cell System 55

As illustrated in FIG. 1, the centrifugal compressor 10 with the above-described configuration is a part of a fuel cell system 55 mounted on a fuel cell vehicle. The fuel cell system 55 includes a fuel cell stack 56, a supply passage 57, and a discharge passage 58, in addition to the centrifugal compressor 10. The fuel cell stack 56 is formed by a plurality of fuel cells. Each of the fuel cells is not illustrated for convenience of explanation. The discharge chamber 24 and the fuel cell stack 56 are connected through the supply passage 57. The fuel cell stack 56 and the suction chamber 29 are connected through the discharge passage 58.

When the rotor 33 rotates, the compressor impeller 49 and the turbine wheel 50 are rotated together with the rotor 33. Thus, the motor 31 rotates the compressor impeller 49. When the compressor impeller 49 rotates, air is drawn from the inlet 22 to the impeller chamber 23. The air flowing in the inlet 22 is cleaned by an air cleaner (not illustrated).

The air drawn from the inlet 22 is compressed by the compressor impeller 49 inside the impeller chamber 23, passes through the compressor diffuser passage 25 and enters the discharge chamber 24. Such compressed air is discharged from the discharge chamber 24 to the supply passage 57. Then, the air discharged from the discharge chamber 24 to the supply passage 57 is supplied to the fuel cell stack 56 through the supply passage 57. The air supplied to the fuel cell stack 56 is used for power generation of the fuel cell stack 56. After that, the air passing through the fuel cell stack 56 is discharged to the discharge passage 58, as exhaust air from the fuel cell stack 56.

The exhaust air from the fuel cell stack 56 is drawn into the suction chamber 29 through the discharge passage 58. The exhaust air from the fuel cell stack 56 drawn into the suction chamber 29 is introduced into the turbine chamber 28 through the communication passage 30. The turbine wheel 50 is rotated by the exhaust air from the fuel cell stack 56 introduced into the turbine chamber 28. The rotor 33 is rotated by, in addition to a drive of the motor 31, the turbine wheel 50 being rotated by the exhaust air from the fuel cell stack 56. The rotation of the rotor 33 is assisted by the turbine wheel 50 rotated by the exhaust air from the fuel cell stack 56. The exhaust air having passed through the turbine chamber 28 is discharged from the outlet 27 to the outside.

### Compressed Air Introduction Port 60

As illustrated in FIG. 3, the housing 11 includes a compressed air introduction port 60. The compressed air introduction port 60 is formed in the second plate 16 and the end wall 12a of the motor housing 12, close to the turbine chamber 28 opposite from the motor chamber 18. The compressed air introduction port 60 includes a first inlet passage 61 and a second inlet passage 62. In the compressed air introduction port 60, the first inlet passage 61 extends through the second plate 16 in the radial direction of the tubular member 41. A first end of the first inlet passage 61 is opened at a part of an outer peripheral surface of the second plate 16. A second end of the first inlet passage 61 is positioned inside the second plate 16. In the compressed air introduction port 60, the second inlet passage 62 extends through the second plate 16 and the end wall 12a of the motor housing 12 in a direction crossing the radial direction of the tubular member 41. A first end of the second inlet passage 62 is continuous with the second end of the first inlet passage 61. A second end of the second inlet passage 62 is opened at a distal end of the second radial bearing holding portion 26.

As illustrated in FIG. 1, the fuel cell system 55 includes a branch passage 59. A first end of the branch passage 59 is connected to the supply passage 57. Thus, the branch passage 59 is branched from the supply passage 57. A second end of the branch passage 59 is connected to the first end of the first inlet passage 61. Thus, the branch passage 59 is connected to the compressed air introduction port 60. An intercooler 59a is disposed in the middle of the branch passage 59. The intercooler 59a cools the air flowing through the branch passage 59. Part of the air flowing through the supply passage 57 flows into the branch passage 59 and is cooled by the intercooler 59a. After that, the cooled air is introduced into the compressed air introduction port 60 through the branch passage 59. The cooled air introduced into the compressed air introduction port 60 through the branch passage 59 is introduced into the motor chamber 18. Thus, part of the air compressed by the compressor impeller 49 is introduced from the compressed air introduction port 60 into the motor chamber 18.

### Nozzle 63

As illustrated in FIG. 3, the centrifugal compressor 10 includes a nozzle 63. The nozzle 63 is a part of the second end of the second inlet passage 62. Thus, the nozzle 63 is provided in the second radial bearing holding portion 26. The nozzle 63 injects the air introduced from the compressed air introduction port 60 into the motor chamber 18 in a state where a pressure of such air is lower than an atmospheric pressure. The nozzle 63 injects the air introduced from the compressed air introduction port 60 toward an inner space of the motor chamber 18, further inside than the second resin portion 39 in a state where the pressure of the air is lower than the atmospheric pressure.

### Axial Passage 65

As illustrated in FIG. 1, the centrifugal compressor 10 includes an axial passage 65. The axial passage 65 includes a first axial passage 66, a magnetic body internal passage 67, and a second axial passage 68. The first axial passage 66 extends through an inside of the first shaft member 44 in an axial direction thereof. The first axial passage 66 has a circular hole shape. A first end of the first axial passage 66 is opened at the second end of the first shaft member 44 and communicates with the inlet 22.

The magnetic body internal passage 67 extends through an inside of the permanent magnet 42 in the axial direction thereof. Thus, the axial passage 65 extends through the inside of the permanent magnet 42. The magnetic body internal passage 67 has a circular hole shape. An inner diameter of the magnetic body internal passage 67 is slightly larger than that of the first axial passage 66. A first end of the magnetic body internal passage 67 communicates with a second end of the first axial passage 66.

The second axial passage 68 extends inside the second shaft member 45 in the axial direction thereof. The second axial passage 68 has a circular hole shape. An inner diameter of the second axial passage 68 is slightly larger than that of the first axial passage 66. The inner diameter of the second axial passage 68 is the same as that of the magnetic body internal passage 67, for example. A first end of the second axial passage 68 communicates with a second end of the magnetic body internal passage 67. A second end of the second axial passage 68 is positioned inside the second shaft member 45. Specifically, the second end of the second axial passage 68 is positioned inside the shaft insertion hole 16h. The second end of the second axial passage 68 is an internal thread hole 68h.

As described above, the axial passage 65 extends inside the first shaft member44, inside the permanent magnet 42, and inside the second shaft member 45, in the axial direction of the tubular member 41. Thus, the axial passage 65 extends inside the rotor 33 in the axial direction thereof. The axial passage 65 is opened at one end of the first shaft member 44 close to the compressor impeller 49 to communicate with the inlet 22.

### Radial Passage 69

The centrifugal compressor 10 includes a plurality of radial passages 69. The plurality of radial passages 69 communicates with the second end of the second axial passage 68. Thus, each of the radial passages 69 communicates with the axial passage 65. Each of the radial passages 69 extends from the second axial passage 68 in the radial direction of the second shaft member 45. A first end of each of the radial passages 69 communicates with the second axial passage 68. Specifically, the first end of each of the radial passages 69 communicates with a part of the second axial passage 68 closer to the first end of the second axial passage 68 than the internal thread hole 68h is. A second end of each of the radial passages 69 is opened at a part of an outer peripheral surface of the second shaft member 45 and communicates with an inside of the shaft insertion hole 16h in the housing 11. Specifically, the second end of each of the radial passages 69 communicates with a part of the inside of the shaft insertion hole 16h closer to the second radial bearing holding portion 26 than the second seal member 47 is. Each of the radial passages 69 communicates with an inside of the motor chamber 18 through the shaft insertion hole 16h and the second radial bearing holding portion 26.

### Connecting Rod 90

The centrifugal compressor 10 includes a connecting rod 90. The connecting rod 90 is made of a magnetic material. The connecting rod 90 extends through the second axial passage 68 and the magnetic body internal passage 67 and projects into the first axial passage 66. Thus, the connecting rod 90 extends through the inside of the permanent magnet 42. One end of the connecting rod 90 close to the second axial passage 68 is an external thread portion 91. The external thread portion 91 is screwed into the internal thread hole 68h of the second axial passage 68. Thus, the external thread portion 91 of the connecting rod 90 is positioned inside the second axial passage 68 with respect to the rotor 33.

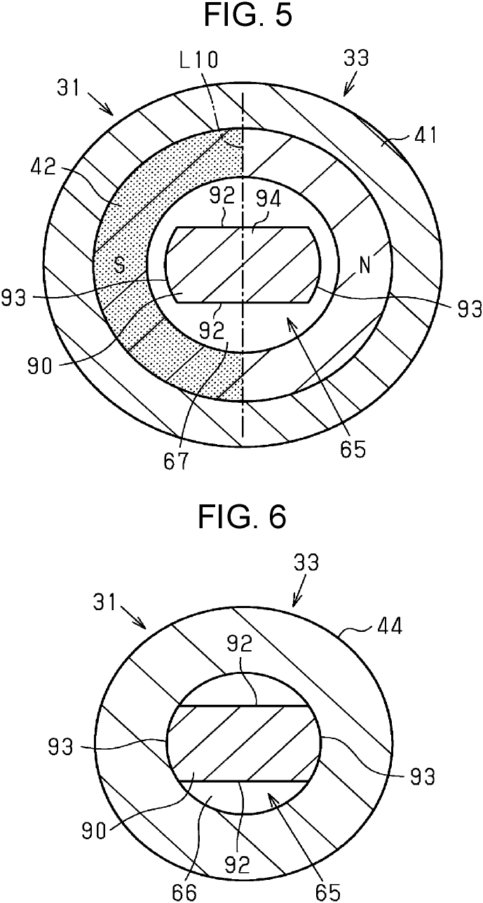

As illustrated in FIG. 5 and FIG. 6, the outer peripheral surface of the connecting rod 90 includes a pair of flat surfaces 92 and a pair of curved surfaces 93. Each of the curved surfaces 93 connects the pair of flat surfaces 92 to each other. A part of the outer peripheral surface of the connecting rod 90 excluding the external thread portion 91 is formed by the pair of flat surfaces 92 and the pair of curved surfaces 93. The pair of flat surfaces 92 extends parallel to each other. The pair of curved surfaces 93 is curved in an arc shape and extends along an inner peripheral surface of the first axial passage 66, an inner peripheral surface of the magnetic body internal passage 67, and an inner peripheral surface of the second axial passage 68.

The pair of flat surfaces 92 and the pair of curved surfaces 93 extend inside the second axial passage 68 and the magnetic body internal passage 67. Thus, the pair of flat surfaces 92 extends parallel to each other at least in a part of the inside of the permanent magnet 42. As illustrated in FIG. 5, the pair of flat surfaces 92 is located in a direction in which a boundary line L10 between the north pole and the south pole of the permanent magnet 42 extends. As illustrated in FIG. 6, the pair of curved surfaces 93 is press-fitted into the inner peripheral surface of the first axial passage 66.

As illustrated in FIG. 1, the pair of curved surfaces 93 is press-fitted into the inner peripheral surface of the first axial passage 66 and the external thread portion 91 is screwed into the internal thread hole 68h, so that the connecting rod 90 connects the first shaft member 44 and the second shaft member 45 to each other. The external thread portion 91 is screwed into the internal thread hole 68h, so that the connecting rod 90 connects the first shaft member 44 and the second shaft member 45 in a state where an axial force is applied to the second shaft member 45.

The axial force is applied from the connecting rod 90 to the second shaft member 45, and the tubular member 41 is thus sandwiched by the first flange portion 44a of the first shaft member 44 and the second flange portion 45a of the second shaft member 45. Thus, the first shaft member 44 and the second shaft member 45 hold the tubular member 41 using the axial force applied from the connecting rod 90 to the second shaft member 45. As a result, the first shaft member 44 and the second shaft member 45 are rotated together with the tubular member41.

The pair of flat surfaces 92 is contactless with the inner peripheral surface of the first axial passage 66, the inner peripheral surface of the magnetic body internal passage 67, and the inner peripheral surface of the second axial passage 68. The pair of curved surfaces 93 is contactless with the inner peripheral surface of the second axial passage 68 and the inner peripheral surface of the magnetic body internal passage 67. As illustrated in FIG. 5, the entire outer peripheral surface of the connecting rod 90 is contactless with the permanent magnet 42.

A part of the connecting rod 90 extending through the inside of the permanent magnet 42 is a magnetic passage forming portion 94 that forms a magnetic passage between the north pole and the south pole of the permanent magnet 42. A gap between each of the flat surfaces 92 and the permanent magnet 42 serves as a part of the axial passage 65. The axial passage 65 extends inside the permanent magnet 42 and outside the magnetic passage forming portion 94 in the radial direction of the tubular member 41. A gap between each of the curved surfaces 93 and the permanent magnet 42 also serves as a part of the axial passage 65. The cross-sectional area of a part of the axial passage 65 between each of the flat surfaces 92 and the permanent magnet 42 is greater than that of a part of the axial passage 65 between each of the curved surfaces 93 and the permanent magnet 42. Therefore, the air flowing through the magnetic body internal passage 67 easily flows through the gap between each of the flat surfaces 92 and the permanent magnet 42 as compared with the gap between each of the curved surfaces 93 and the permanent magnet 42. As described above, the gap is formed between the connecting rod 90 and an inner surface of the permanent magnet 42 to serve as a part of the axial passage 65.

### Air Flow

As illustrated in FIG. 1, the air drawn from the inlet 22 is introduced into the first end of the first axial passage 66. Then, the air introduced from the inlet 22 into the first axial passage 66 passes through the first axial passage 66, the magnetic body internal passage 67, the second axial passage 68, and each of the radial passages 69, and is introduced into the shaft insertion hole 16h. The air introduced into the shaft insertion hole 16h passes through the inside of the second radial bearing holding portion 26 and is introduced into the motor chamber 18.

### Mixing Space 71

As illustrated in FIG. 4, the centrifugal compressor 10 includes a mixing space 71. The mixing space 71 is the inner space of the motor chamber 18, further inside than the second resin portion 39. Thus, the mixing space 71 is located at a position where the nozzle 63 injects the air. In the mixing space 71, the air having passed through the shaft insertion hole 16h and the second radial bearing holding portion 26 and having flowed into the motor chamber 18 is mixed with the air injected from the nozzle 63. As a result, in the mixing space 71, the air introduced into the motor chamber 18 through the radial passages 69 is mixed with the compressed air injected from the nozzle 63. As described above, the mixing space 71 is located in a part of the motor chamber 18 between the motor 31 and the second radial bearing holding portion 26. Then, the air introduced from each of the radial passages 69 into the motor chamber 18 passes through the inside of the second radial bearing holding portion 26 from a side of the second radial bearing holding portion 26 opposite from the motor 31 in the axial direction of the rotor 33, and is mixed with the compressed air injected from the nozzle 63 in the mixing space 71.

### Diffuser Passage 72

The centrifugal compressor 10 incudes a diffuser passage 72. The diffuser passage 72 is a space formed between the inner peripheral surface of the third resin portion 40 and an outer peripheral surface of the tubular member 41. Thus, the diffuser passage 72 is located between the stator 32 and the rotor 33. The mixing space 71 that is the inner space of the motor chamber 18, further inside than the second resin portion 39, is communicated with a discharge space 73 that is an inner space of the motor chamber 18, further inside than the first resin portion 38, through the diffuser passage 72. The diffuser passage 72 is narrowed so as to minimize a cross-sectional area of a part of the diffuser passage 72 that is closest to the mixing space 71. The cross-sectional area of a part of the diffuser passage 72 that is closest to the discharge space 73 is maximized. Thus, the cross-sectional area of the diffuser passage 72 gradually increases from the mixing space 71 toward the discharge space 73. Then, in the diffuser passage 72, a pressure of the air introduced from the mixing space 71 increases.

### Discharge Port 80

As illustrated in FIG. 2, the housing 11 includes a discharge port 80. The discharge port 80 is formed in the first plate 15, closer to the impeller chamber 23 than the motor chamber 18 is. The discharge port 80 extends inside the first plate 15 in the radial direction of the tubular member 41. A first end of the discharge port 80 is opened at an outer peripheral surface of the first plate 15. A second end of the discharge port 80 is located inside the first plate 15. The air having passed through the inlet 22, the axial passage 65, and each of the radial passages 69 is introduced into the motor chamber 18, and is then discharged from the discharge port 80 to the outside of the housing 11.

First Discharge Passage 81, Second Discharge Passage 82, and Third Discharge Passage 83

The housing 11 includes a first discharge passage 81, a second discharge passage 82, and a third discharge passage 83. The first discharge passage 81 extends through an inside of the first plate 15. The first discharge passage 81 connects the inside of the first radial bearing holding portion 21 and the discharge port 80. A first end of the first discharge passage 81 communicates with the inside of the first radial bearing holding portion 21. A second end of the first discharge passage 81 communicates with the discharge port 80. The air inside the first radial bearing holding portion 21 flows toward the discharge port 80 through the first discharge passage 81.

The second discharge passage 82 extends through the inside of the first plate 15. The second discharge passage 82 connects the motor chamber 18 and the thrust bearing accommodation chamber 19. A first end of the second discharge passage 82 communicates with a space inside the motor chamber 18 closer to the first plate 15 than the stator 32 is. A second end of the second discharge passage 82 is opened at an inner peripheral surface of the second recess 15d. Then, the second end of the second discharge passage 82 communicates with the thrust bearing accommodation chamber 19. The air inside the motor chamber 18 flows toward the thrust bearing accommodation chamber 19 through the second discharge passage 82.

The third discharge passage 83 extends through an inside of the seal plate 17 and the inside of the first plate 15. The third discharge passage 83 connects the shaft insertion hole 17h and the discharge port 80. A first end of the third discharge passage 83 communicates with an inside of the shaft insertion hole 17h. A second end of the third discharge passage 83 communicates with the discharge port 80. Thus, the third discharge passage 83 is connected to the thrust bearing accommodation chamber 19 through the shaft insertion hole 17h. The air inside the thrust bearing accommodation chamber 19 flows toward the discharge port 80 from a wall portion of the thrust bearing accommodation chamber 19 close to the first thrust bearing portion 53a through the third discharge passage 83.

### Operations

Next, the following will explain operations of the present embodiment.

Part of the air compressed by the compressor impeller 49 and discharged into the supply passage 57 is introduced into the compressed air introduction port 60 through the branch passage 59. The air introduced into the compressed air introduction port 60 is injected from the nozzle 63 toward the mixing space 71. The pressure of the air injected from the nozzle 63 toward the mixing space 71 is lower than the atmospheric pressure. Thus, a negative pressure is generated in the mixing space 71 at a position where the nozzle 63 injects the air.

On the other hand, part of the air drawn from the inlet 22 is introduced into the axial passage 65 and flows through the axial passage 65 and each of the radial passages 69. Due to the centrifugal force along with rotation of the second shaft member 45, the air flowing through each of the radial passages 69 flows in a radially outward direction of the second shaft member 45 and is introduced from each of the radial passages 69 into the shaft insertion hole 16h. At this time, the air passing through the axial passage 65 flows through each of the radial passages 69 in the radially outward direction of the second shaft member 45 due to a centrifugal force along with rotation of the second shaft member 45, so that the negative pressure is generated in a part of the axial passage 65 through which the air flows through the inside of the second shaft member 45. As a result, part of the air from the inlet 22 is easily drawn toward the axial passage 65. Thus, the air easily flows through the axial passage 65. Therefore, the air passing through the axial passage 65 efficiently cools the permanent magnet 42.

Furthermore, the air introduced into the shaft insertion hole 16h passes through the inside of the second radial bearing holding portion 26. Therefore, the air passing through the inside of the second radial bearing holding portion 26 cools the second radial bearing 52.

Then, the air having passed through the inside of the second radial bearing holding portion 26 is introduced into the mixing space 71. At this time, the negative pressure is generated in the mixing space 71. Thus, the air introduced from each of the radial passages 69 is easily drawn toward the mixing space 71. In the mixing space 71, the compressed air injected from the nozzle 63 is mixed with the air that passes through the inside of the second radial bearing holding portion 26 and is introduced into the mixing space 71. In the diffuser passage 72, the pressure of the air introduced from the mixing space 71 increases and such air flows toward the discharge space 73.

Part of the air discharged from the diffuser passage 72 into the discharge space 73 passes through the inside of the first radial bearing holding portion 21. Thus, the air passing through the inside of the first radial bearing holding portion 21 cools the first radial bearing 51. The air having passed through the first radial bearing holding portion 21 is discharged from the discharge port 80 to the outside of the motor chamber 18 through the first discharge passage 81. As described above, the air having passed through the diffuser passage 72 in the motor chamber 18 passes through the inside of the first radial bearing holding portion 21 and is then discharged from the discharge port 80 to the outside of the motor chamber 18 through the first discharge passage 81.

Part of the air discharged from the diffuser passage 72 into the discharge space 73 passes from the space inside the motor chamber 18 closer to the first plate 15 than the stator 32 is, through the second discharge passage 82 and flows into the thrust bearing accommodation chamber 19. Then, the air having flowed into the thrust bearing accommodation chamber 19 is branched into air flowing toward the first thrust bearing portion 53a and air flowing toward the second thrust bearing portion 53b.

The air having flowed toward the first thrust bearing portion 53a is discharged from the discharge port 80 to the outside of the motor chamber 18 through the third discharge passage 83. Thus, the air flowing toward the first thrust bearing portion 53a inside the thrust bearing accommodation chamber 19 cools the first thrust bearing portion 53a. Furthermore, the thrust bearing accommodation chamber 19 communicates with the first radial bearing holding portion 21. Thus, the air flowing toward the second thrust bearing portion 53b flows into the first radial bearing holding portion 21 and is discharged from the discharge port 80 to the outside of the motor chamber 18 through the first discharge passage 81. Therefore, the air having flowed toward the second thrust bearing portion 53b inside the thrust bearing accommodation chamber 19 cools the second thrust bearing portion 53b. As a result, the thrust bearing 53 is efficiently cooled by the air.

As described above, the air outside the housing 11 is introduced from the inlet 22 into the motor chamber 18 through the axial passages 65 and the radial passages 69 to cool the magnetic body, and the air introduced into the motor chamber 18 is discharged from the discharge port 80.

The connecting rod 90 is made of the magnetic material to form the magnetic passage between the permanent magnet 42 and the connecting rod 90. The gap is formed between the connecting rod 90 and the inner surface of the permanent magnet 42 to serve as a part of the axial passage 65. Thus, the connecting rod 90 forms the magnetic passage between the permanent magnet 42 and the connecting rod 90 and serves as a part of the axial passage 65. Therefore, the air flowing through the axial passage 65 cools the permanent magnet 42, and the connecting rod 90 forms the magnetic passage between the permanent magnet 42 and the connecting rod 90, which improves an output of the motor 31.

### Effects

The above-described embodiment provides the following advantageous effects.

Part of the air drawn from the inlet 22 is introduced into the axial passage 65 and flows through the axial passage 65 and each of the radial passages 69. Due to the centrifugal force along with rotation of the second shaft member 45, the air flowing through each of the radial passages 69 flows in the radially outward direction of the second shaft member 45 and is introduced from each of the radial passages 69 into the motor chamber 18. The air introduced into the motor chamber 18 is discharged from the discharge port 80. The air flowing through the axial passage 65 cools the permanent magnet 42. Thus, the permanent magnet 42 is cooled by air at a temperature lower than a temperature of the compressed air. At this time, the air passing through the axial passage 65 flows through each of the radial passages 69 in the radially outward direction of the second shaft member 45 due to the centrifugal force along with rotation of the second shaft member 45, so that the negative pressure is generated in a part of the axial passage 65 through which the air passes inside the second shaft member 45. As a result, part of the air from the inlet 22 is easily drawn toward the axial passage 65. Thus, the air easily flows through the axial passage 65. Therefore, the permanent magnet 42 is efficiently cooled.

The rotor 33 includes the connecting rod 90. The connecting rod 90 is made of the magnetic material to form the magnetic passage between the permanent magnet 42 and the connecting rod 90. The connecting rod 90 connects the first shaft member 44 and the second shaft member 45 to form the gap serving as a part of the axial passage 65 between the connecting rod 90 and the inner surface of the permanent magnet 42. Thus, the connecting rod 90 forms the magnetic passage between the permanent magnet 42 and the connecting rod 90 and serves as a part of the axial passage 65. Therefore, the connecting rod 90 forms the magnetic passage between the permanent magnet 42 and the connecting rod 90 while the air flowing through the axial passage 65 cools the permanent magnet 42. As described above, the permanent magnet 42 is efficiently cooled while improving the output of the motor 31.

The first shaft member 44 and the second shaft member 45 hold the tubular member 41 using an axial force applied from the connecting rod 90 to the second shaft member 45, so that the first shaft member 44 and the second shaft member 45 are rotated together with the tubular member 41. Such a configuration for the connecting rod 90 is preferable in that the connecting rod 90 connects the first shaft member 44 and the second shaft member 45 and forms the gap serving as a part of the axial passage 65 between the connecting rod 90 and the inner surface the permanent magnet 42.

The gap between each of the flat surfaces 92 and the permanent magnet 42 serves as a part of the axial passage 65. As a result, the cross-sectional area of a part of the axial passage 65 extending through the inside of the permanent magnet 42 is secured as much as possible, while the cross-sectional area of the connecting rod 90 is secured as much as possible. Therefore, the magnetic passage formed in the connecting rod 90 between the north pole and the south pole is secured as much as possible, while a pressure drop of the air flowing through the axial passage 65 is suppressed.

The entire outer peripheral surface of the connecting rod 90 is contactless with the permanent magnet 42. Thus, the gap between the entire outer peripheral surface of the connecting rod 90 and the permanent magnet 42 serves as the axial passage 65. Therefore, a contact area of the permanent magnet 42 being in contact with the air flowing through the axial passage 65 increases, so that the permanent magnet 42 is further efficiently cooled.

The pressure of the air injected from the nozzle 63 into the motor chamber 18 is lower than the atmospheric pressure. Thus, the negative pressure is generated in the mixing space 71 at a position where the nozzle 63 injects the air, so that the air introduced from each of the radial passages 69 into the motor chamber 18 is easily drawn into the mixing space 71. In the diffuser passage 72, the pressure of the air from the mixing space 71 increases, and such air flows toward the discharge port 80 and is discharged from the discharge port 80. Therefore, the air introduced from each of the radial passages 69 into the motor chamber 18 is easily drawn into the mixing space 71, and the air inside the motor chamber 18 is easily discharged from the discharge port 80. As a result, part of the air from the inlet 22 is easily drawn toward the axial passage 65. Therefore, the air further easily flows through the axial passage 65, which further efficiently cools the permanent magnet 42.

The air introduced from each of the radial passages 69 into the housing 11 passes through the inside of the second radial bearing holding portion 26 from one side of the second radial bearing holding portion 26 opposite from the motor 31 in the axial direction of the tubular member 41 is mixed with the compressed air injected from the nozzle 63 in the mixing space 71. As a result, the air cools the permanent magnet 42 and further cools the second radial bearing 52. Thus, the air at a temperature lower than a temperature of the compressed air efficiently cools the second radial bearing 52, in addition to the permanent magnet 42.

The housing 11 includes the first discharge passage 81, the second discharge passage 82, and the third discharge passage 83. With this configuration, the air having passed through the diffuser passage 72 in the motor chamber 18 passes through the inside of the first radial bearing holding portion 21 and is then discharged from the discharge port 80 through the first discharge passage 81. Thus, the air passing through the inside of the first radial bearing holding portion 21 cools the first radial bearing 51. The air having passed through the diffuser passage 72 in the motor chamber 18 flows into the thrust bearing accommodation chamber 19 through the second discharge passage 82. Then, the air having flowed into the thrust bearing accommodation chamber 19 is branched into the air flowing toward the first thrust bearing portion 53a and the air flowing toward the second thrust bearing portion 53b. The air having flowed toward the first thrust bearing portion 53a is discharged from the discharge port 80 through the third discharge passage 83. Thus, the air flowing toward the first thrust bearing portion 53a inside the thrust bearing accommodation chamber 19 cools the first thrust bearing portion 53a. Furthermore, since the thrust bearing accommodation chamber 19 communicates with the first radial bearing holding portion 21, the air having flowed toward the second thrust bearing portion 53b flows into the first radial bearing holding portion 21 and is discharged from the discharge port 80 to the outside of the motor chamber 18 through the first discharge passage 81. Thus, the air flowing toward the second thrust bearing portion 53b inside the thrust bearing accommodation chamber 19 cools the second thrust bearing portion 53b. Therefore, the air efficiently cools the thrust bearing 53. As described above, the permanent magnet 42, the first radial bearing 51, the second radial bearing 52, and the thrust bearing 53 are efficiently cooled.

Part of the air compressed by the compressor impeller 49 is introduced from the compressed air introduction port 60 into the motor chamber 18 in order to efficiently introduce the air at a temperature lower than a temperature of the compressed air into the motor chamber 18. Thus, a flow rate of the air introduced from the compressed air introduction port 60 into the motor chamber 18 is relatively lower than a flow rate of air required for cooling the permanent magnet 42. Therefore, the air compressed by the compressor impeller 49 is efficiently supplied to the fuel cell stack 56. As a result, a compression efficiency of the centrifugal compressor 10 is improved.

### Modifications

The above-described embodiment may be modified as follows. The embodiment may be combined with the following modifications within technically consistent range.

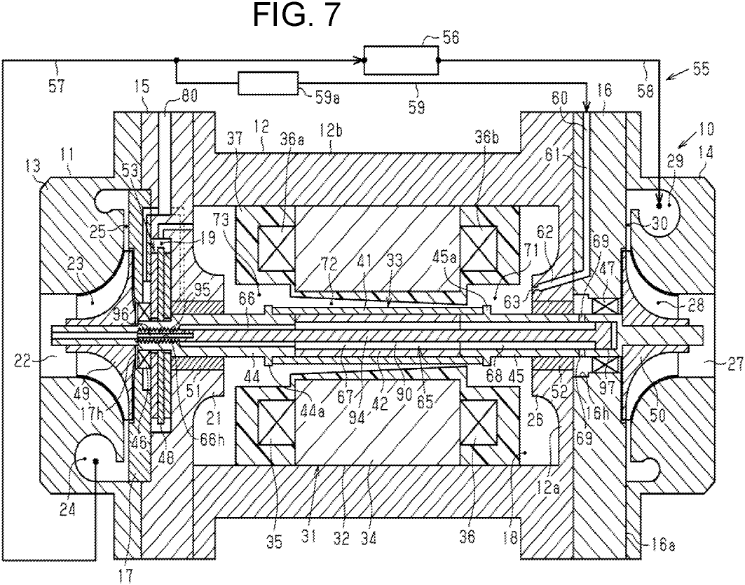

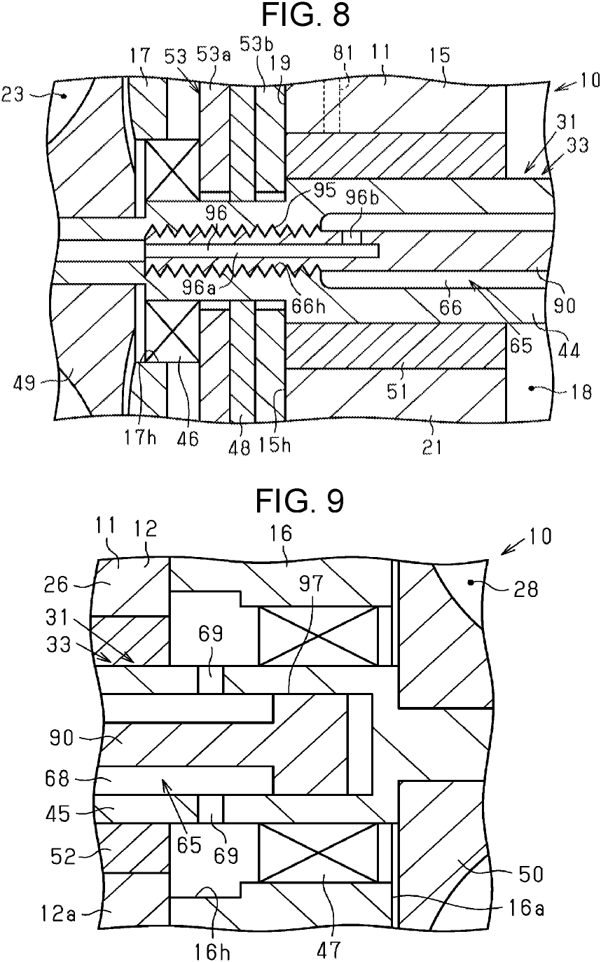

As illustrated in FIG. 7, FIG. 8, and FIG. 9, the connecting rod 90 may connect the first shaft member 44 and the second shaft member 45 in a state where the axial force is applied to the first shaft member 44. That is, the connecting rod 90 is simply required to connect the first shaft member 44 and the second shaft member 45 in a state where the axial force is applied to the first shaft member 44 or the second shaft member 45.

As illustrated in FIG. 8, an internal thread hole 66h is formed in an inner peripheral surface of the first axial passage 66. One end portion of the connecting rod 90 close to the first axial passage 66 is an external thread portion 95. The external thread portion 95 can be screwed into the internal thread hole 66h of the first axial passage 66.

The connecting rod 90 includes a rod internal passage 96. The rod internal passage 96 communicates with a part of the first axial passage 66 closer to a first end of the first axial passage 66 than the internal thread hole 66h is, and a part of the first axial passage 66 closer to a second end of the first axial passage 66 than the internal thread hole 66h is. The rod internal passage 96 includes a rod internal axial passage 96a and a rod internal radial passage 96b. The rod internal axial passage 96a extends through the inside of the connecting rod 90 in the axial direction thereof. A first end of the rod internal axial passage 96a communicates with a part of the first axial passage 66 closer to the first end of the first axial passage 66 than the internal thread hole 66h is. The rod internal radial passage 96b communicates with a second end of the rod internal axial passage 96a. The rod internal radial passage 96b communicates with a part of the first axial passage 66 closer to the second end of the first axial passage 66 than the internal thread hole 66h is. The second end of the rod internal axial passage 96a is communicated with a part of the first axial passage 66 closer to the second end of the first axial passage 66 than the internal thread hole 66h is, through the rod internal radial passage 96b.

The air flowing through a part of the first axial passage 66 closer to the first end of the first axial passage 66 than the internal thread hole 66h is, is introduced into the rod internal axial passage 96a and flows through the rod internal axial passage 96a and the rod internal radial passage 96b. The air flowing through the rod internal radial passage 96b flows in the radially outward direction of the tubular member 41 due to the centrifugal force along with rotation of the first shaft member 44. The air flowing in the radially outward direction of the tubular member 41 is introduced from the rod internal radial passage 96b into a part of the first axial passage 66 closer to the second end of the first axial passage 66 than the internal thread hole 66h is.

As illustrated in FIG. 9, an end portion of the connecting rod 90 close to the second axial passage 68 is a press-fit portion 97. The press-fit portion 97 is press-fitted in the inner peripheral surface of the second axial passage 68. The press-fit portion 97 is press-fitted into the inner peripheral surface of the second axial passage 68 closer to the second end of the second axial passage 68 than each of the radial passages 69 is.

The connecting rod 90 connects the first shaft member 44 and the second shaft member 45 by the external thread portion 95 being screwed into the internal thread hole 66h and by the press-fit portion 97 being press-fitted in the inner peripheral surface of the second axial passage 68. The connecting rod 90 connects the first shaft member 44 and the second shaft member 45 in a state where the axial force is applied to the first shaft member 44 by the external thread portion 95 being screwed into the internal thread hole 66h.

The tubular member 41 is sandwiched between the first flange portion 44a of the first shaft member 44 and the second flange portion 45a of the second shaft member 45 along with the axial force applied by the connecting rod 90 to the first shaft member 44. Therefore, the first shaft member 44 and the second shaft member 45 hold the tubular member 41 using the axial force applied from the connecting rod 90 to the first shaft member 44. As a result, the first shaft member 44 and the second shaft member 45 are rotated together with the tubular member 41. As described above, the first shaft member 44 and the second shaft member 45 hold the tubular member 41 using the axial force applied from the connecting rod 90 to the first shaft member 44. That is, the first shaft member 44 and the second shaft member 45 are simply required to hold the tubular member 41 using the axial force applied from the connecting rod 90 to the first shaft member 44 or the second shaft member 45.

In the embodiments, in the rotor 33, the tubular member 41 and the first shaft member 44 may be fixed to each other, and the tubular member 41 and the second shaft member 45 may be fixed to each other.

In the embodiments, instead of the pair of flat surfaces 92, for example, a pair of recesses may be formed in the outer peripheral surface of the connecting rod 90. Then, a gap between each of the pair of recesses and the permanent magnet 42 may serve as a part of the axial passage 65.

In the embodiments, the pair of curved surfaces 93 may be in contact with the permanent magnet 42. That is, the entire outer peripheral surface of the connecting rod 90 need not be contactless with the permanent magnet 42.

In the embodiments, each of the radial passages 69 need not communicate with the shaft insertion hole 16h. Each of the radial passages 69 may communicate with the mixing space 71, for example. Thus, the axial passage 65 need not communicate with the shaft insertion hole 16h, and may communicate with the mixing space 71, for example. As described above, the air introduced from each of the radial passages 69 into the housing 11 need not pass through the inside of the second radial bearing holding portion 26 from one side thereof opposite from the motor 31.

In the embodiments, the discharge port 80 may be formed in the circumferential wall 12b of the motor housing 12, for example. The discharge port 80 may communicate with the space inside the motor chamber 18 closer to the first plate 15 than the stator 32 is. In this case, the housing 11 need not include the first discharge passage 81, the second discharge passage 82, and the third discharge passage 83.

In the embodiments, the inner peripheral surface of the stator core 34 need not be covered with a resin. The inner peripheral surface of the stator core 34 may be a cone hole that increases in an inner diameter of the stator core 34 from the second coil end 36b toward the first coil end 36a. As described above, the diffuser passage 72 may be formed between the inner peripheral surface of the stator core 34 and the outer peripheral surface of the tubular member 41.

In the embodiments, the inner diameter of the inner peripheral surface of the third resin portion 40 may be fixed in a certain size. The outer peripheral surface of the tubular member 41 may be a conical surface that increases in an outer diameter of the tubular member 41 from the second shaft member 45 toward the first shaft member 44. The diffuser passage 72 may be formed between the inner peripheral surface of the third resin portion 40 and the outer peripheral surface of the tubular member 41. That is, the diffuser passage 72 is simply required to be formed between the stator 32 and the rotor 33.

In the embodiments, the housing 11 need not include the compressed air introduction port 60. Then, the centrifugal compressor 10 need not include the nozzle 63, the mixing space 71, and the diffuser passage 72.

In the embodiments, the supporting portion 48 may be formed together with the first shaft member 44.

In the embodiments, the permanent magnet 42 need not be press-fitted in the inner peripheral surface of the tubular member 41 and may be adhered to the inner peripheral surface of the tubular member 41 with an adhesive, for example. That is, the permanent magnet 42 is simply required to be fixed inside the tubular member41.

In the embodiments, the centrifugal compressor 10 need not include the turbine wheel 50.

In the embodiments, the centrifugal compressor 10 may include compressor impellers, instead of the turbine wheel 50. That is, in the centrifugal compressor 10, the compressor impellers may be attached to the first shaft member 44 and the second shaft member 45, respectively, and the air compressed by one of the compressor impellers may be compressed again by the other of the compressor impellers.

In the embodiments, the magnetic body is not limited to the permanent magnet 42 and may be a laminated core, an amorphous core, or a dust core, for example.

In the embodiments, the tubular member 41 may be made of carbon fiber reinforced plastic, for example. That is, the tubular member 41 may be made of any material.

In the embodiments, the centrifugal compressor 10 need not be mounted to the fuel cell vehicle. The centrifugal compressor 10 may be used for a vehicle air conditioner and may be configured to compress refrigerant as air, for example. The centrifugal compressor 10 may be mounted to anything other than the vehicle.

What is claimed is:

1. A centrifugal compressor comprising:
a compressor impeller that compresses air;
a motor that rotates the compressor impeller; and
a housing including an impeller chamber accommodating the compressor impeller, a motor chamber accommodating the motor, and an inlet from which the air is drawn into the impeller chamber,
the motor including a stator fixed to the housing, and a rotor disposed inside the stator,
the rotor including a tubular member, a magnetic body fixed to an inside of the tubular member, and a first shaft member and a second shaft member provided on opposite sides of the magnetic body in an axial direction of the tubular member,
the compressor impeller being connected to the first shaft member, wherein
the rotor includes:
an axial passage that extends inside the rotor in an axial direction of the rotor and is opened at one end of the first shaft member close to the compressor impeller to communicate with the inlet;
a radial passage that communicates with the axial passage and extends in a radial direction of the second shaft member to communicate with the motor chamber; and
a connecting rod made of a magnetic material, the connecting rod connecting the first shaft member and the second shaft member and forming a gap serving as a part of the axial passage between an inner surface of the magnetic body and the connecting rod,
the housing includes a discharge port from which the air introduced into the motor chamber is discharged to an outside of the housing,
the air outside the housing is introduced from the inlet into the motor chamber through the axial passage and the radial passage to cool the magnetic body, and
the air introduced into the motor chamber is discharged from the discharge port.

2. The centrifugal compressor according to claim 1, wherein
the connecting rod connects the first shaft member and the second shaft member in a state where an axial force is applied to the first shaft member or the second shaft member, and
the first shaft member and the second shaft member hold the tubular member using the axial force applied from the connecting rod to the first shaft member or the second shaft member.

3. The centrifugal compressor according to claim 1, wherein
an outer peripheral surface of the connecting rod includes a pair of flat surfaces that extends parallel to each other and is positioned at least in a part of an inside of the magnetic body,
the magnetic body having a cylindrical shape is magnetized in a radial direction of the magnetic body to have a north pole and a south pole on opposite sides of the magnetic body in the radial direction of the magnetic body,
the pair of flat surfaces is located in a direction in which a boundary line between the north pole and the south pole of the magnetic body extends, and
a gap between each of the flat surfaces and the magnetic body serves as a part of the axial passage.

4. The centrifugal compressor according to claim 1, wherein
an entire outer peripheral surface of the connecting rod is contactless with the magnetic body.

5. The centrifugal compressor according to claim 1, further comprising:
a compressed air introduction port that is formed in the housing and from which part of the air compressed by the compressor impeller is introduced into the motor chamber;
a nozzle that injects the air introduced from the compressed air introduction port into the motor chamber in a state where a pressure of the airfrom the compressed air introduction port is lower than an atmospheric pressure;
a mixing space that is located at a position where the nozzle injects the air and in which the air introduced from the radial passage into the motor chamber is mixed with the air injected from the nozzle; and
a diffuser passage that is provided between the stator and the rotor and through which the air introduced from the mixing space flows toward the discharge port while increasing a pressure of the air from the mixing space.

6. The centrifugal compressor according to claim 5 further comprising:
a first radial bearing rotatably supporting the first shaft member in the radial direction; and
a second radial bearing rotatably supporting the second shaft member in the radial direction, wherein
the housing includes:
a first radial bearing holding portion that holds the first radial bearing and communicates with the motor chamber; and
a second radial bearing holding portion that holds the second radial bearing and communicates with the motor chamber,
the nozzle is provided in the second radial bearing holding portion,
the mixing space is located between the motor in the motor chamber and the second radial bearing holding portion, and
the air introduced from the radial passage into the housing passes through an inside of the second radial bearing holding portion from a side of the second radial bearing holding portion opposite from the motor in an axial direction of the rotor and is mixed with the air injected from the nozzle in the mixing space.

7. The centrifugal compressor according to claim 6 further comprising
a thrust bearing that is provided between the compressor impeller and the first radial bearing and rotatably supports the rotor in a thrust direction, wherein
the housing includes a thrust bearing accommodation chamber that communicates with the first radial bearing holding portion and accommodates the thrust bearing,
a supporting portion has an annular shape, is provided on an outer peripheral surface of the first shaft member inside the thrust bearing accommodation chamber, and rotates together with the first shaft member,
the thrust bearing includes:
a first thrust bearing portion disposed closer to the compressor impeller than the supporting portion is; and
a second thrust bearing portion disposed closer to the first radial bearing than the supporting portion is, and
the housing includes:
a first discharge passage through which air inside the first radial bearing holding portion flows toward the discharge port;
a second discharge passage through which air inside the motor chamber flows toward the thrust bearing accommodation chamber; and
a third discharge passage through which air inside the thrust bearing accommodation chamber flows toward the discharge port from a wall portion of the thrust bearing accommodation chamber close to the first thrust bearing portion.
